(19) United States
(12) Patent Application Publication
(10) Pub. No.: US 2003/0160372 A1
(43) Pub. Date: Aug. 28, 2003

(54) Fixing element with multifunctional fixing component

(75) Inventors: Bernd Klitsch, Numbrecht (DE); Stefan Brehm, Hennef (DE); Michael Muller, Hennef (DE)

Correspondence Address: COHEN, PONTANI, LIEBERMAN & PAVANE, 551 FIFTH AVENUE, SUITE 1210, NEW YORK, NY, 10176, US

(73) Assignee: Mannesmann Sachs AG

(21) Appl. No.: 10/370,122

(22) Filed: Feb. 19, 2003

(30) Foreign Application Priority Data
Feb. 27, 2002 (DE) 102 08 560.9-12

(51) Int. Cl. F16F 7/00

(52) U.S. Cl. 267/195; 188/322.19

(57) ABSTRACT

A shock absorber includes a container tube, a piston arranged therein such that it can be displaced in a damping medium, a piston rod connected to the piston, and a fixing component to connect the damping element to one of two masses to be held with little oscillation in relation to each other, the piston rod being connected to the other of the masses. The fixing component, which includes a base with a centering attachment, a stem, and a fork for connecting the fixing component to the first mass, is made as one piece, consists of steel and is preferably a forged component. The fixing component is a multifunctional part whose configuration can be worked into a forged shape in order to facilitate large-scale mass production.

### BACKGROUND OF THE INVENTION

1. Field of the Invention

The invention relates to a damping element between two masses, comprising a container tube, a piston arranged therein such that it can be displaced in a damping medium, a piston rod connected to the piston and a fixing component to connect the damping element to one of the two masses to be held with little oscillation in relation to each other, the piston rod being connected to the other of the masses.

2. Description of the Related Art

Damping elements or shock absorbers of the aforementioned type are used, for example, on vehicles between a first mass, namely the passenger compartment to be kept free of oscillations, and a second mass, namely the wheels, which are subject to oscillations during driving operation. I is also being possible for the first mass also to be a washing machine and the second mass a washing drum filled with laundry. In any case, the damping element is connected by means of a piston rod to the first mass, for example, and by a fixing component to the second mass, the piston rod being attached to a piston which, in a container tube connected to the fixing component, filled with a damping medium and belonging to the damping element, executes oscillatory movements corresponding to the relative oscillatory movements of the two masses in relation to each other.

In specific embodiments, the fixing component on the damping element is equipped with a fork for pivotable fixing to the second mass, this fork having on its two ends holes in order to mount the damping element in an articulated manner on the second mass by means of a bolt pushed through. According to the prior art, this fork is arranged on a stem and the latter in turn on a base of the container tube, this base being a disk which is welded to the container tube in order to seal the latter. This disk is therefore welded to the stem and the latter is welded to the fork in order to ensure the functions of “sealing” and “fixing”.

### SUMMARY OF THE INVENTION

The subject of the present invention provides for the combination of the three parts, namely the base, the stem and the fork, in a single part, in order to permit a production process which is cost-effective, but above all suitable for large-scale mass production. Furthermore, increased strength of the component is achieved, detrimental effects from the welding operation being dispensed with. The advantages of these measures are obvious: the fixing component is provided as a forged component, because this results in machining by removing material being reduced to a minimum and because the welding work which was previously necessary is dispensed with. The weight of the fixing component can be reduced if, in terms of its dimensions, it is matched to the kinking and bending requirements. Particular attention has to be paid here to the stem, whose cross section can have a profile which, for example, is a double T profile, which does not present any difficulties to the “forging” production process.

The present invention has there taken as its object the production of a damping element, comprising a container tube, a piston arranged such as to be displaceable therein, a piston rod connected to said piston and a fixing component, in a cost-effective way and with little expenditure on assembly, by means of economization of the fixing component.

According to the invention, the fixing component includes a base, a stem, and a fork which are manufactured as a simple piece.

An exemplary embodiment of a fixing component and its arrangement on a container tube of a damping element will be explained by using a number of drawings.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a damping element, comprising a container tube, a piston arranged therein such that it can be displaced, a piston rod connected to said piston and a fixing component in section;

FIG. 2 shows the damping element according to FIG. 1 with a profile on a stem of the fixing component;

FIG. 3 shows the arrangement of the fixing component on the container tube via a base in an enlarged illustration; and

FIG. 4 shows the fixing part with a fork on one side and a base on the other side of the stem, in a perspective view.

### DETAILED DESCRIPTION OF THE PRESENTLY PREFERRED EMBODIMENTS

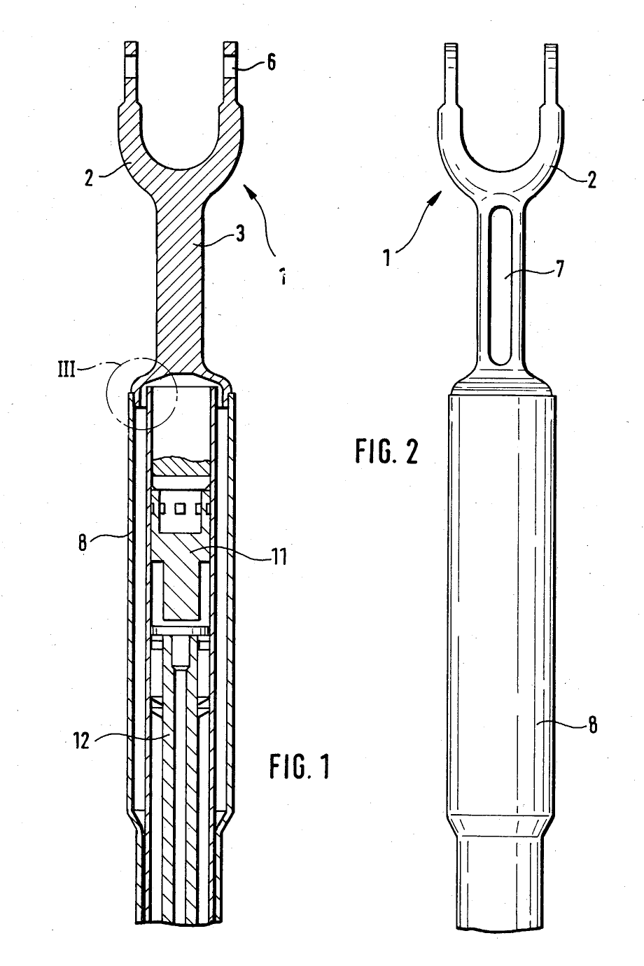

FIG. 1 illustrates a damping element for damping the oscillations of two masses, comprising a container tube 8, a piston 11 arranged therein so as to be displaceable in a cylinder tube 9, a piston rod 12 connected to said piston 11 and a fixing component 1. The fixing component 1, configured in one piece, in turn comprises a base 4 with a centering extension 5, a stem 3 and a fork 2 with fixing holes 6.

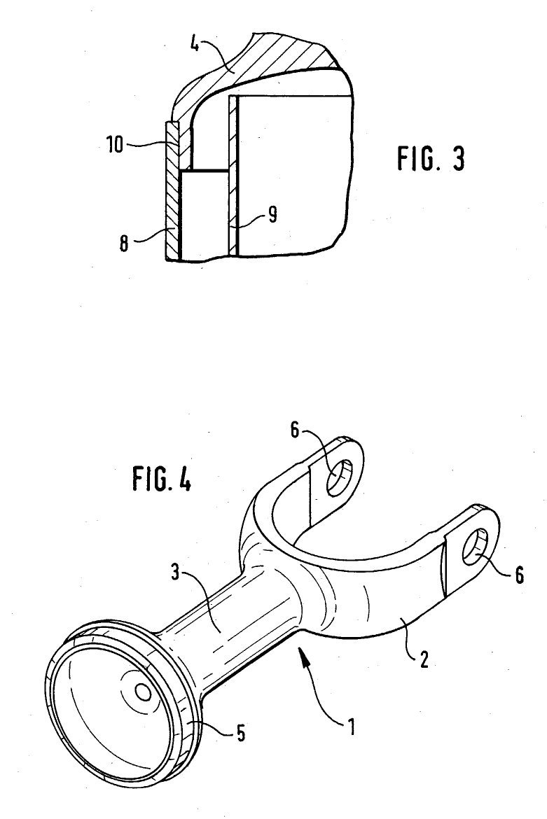

The damping element is connected, for example, to the first mass by means of the piston rod 12 and by the fixing component 1 to the second mass, the piston rod 12 being connected to the piston 11 which, in the cylinder pipe 9 connected to the fixing component 1 and belonging to the damping element, carries out oscillatory movements corresponding to the relative oscillatory movements of the two masses in relation to each other. The container tube 8 is preferably under pressure prestress and is filled with at least one damping medium. It is therefore closed off hermetically and sealed around the piston rod 12, while at the other end it is closed by the base 4 of the fixing component 1, the base 4 with its centering extension 5 according to FIG. 3 being connected to the container tube 8 via a connecting point 10.

The centering attachment 5 is designed in such a way that it can be pushed into the end of the container tube 8, it being possible for a stop on the centering attachment 5 to be helpful in aligning the fixing component 1 of the same axis as the container tube 8. The diameter of the centering extension 5 should have a press fit or a clearance fit for its connection to the container tube 8, irrespective of how the fixing of the fixing component 1 to the container tube 8 appears. This can be achieved by adhesive bonding, welding, jointing, soldering or else by deforming the end of the container tube 8, for example by means of leakproof rolling.

As becomes clear from FIG. 4, the fixing component 1 has to be machined by material removal only at the base 4 and at the holes 6. In detail, the fixing component 1 has to be centered and turned at the base 4, while at the holes 6 it has to be milled and drilled. This machining, highly economized as compared with the prior art, has become possible by means of the precise forging process which can be used in large-scale mass production, in which an incandescent blank is pressed between two mirror-identical half tools and is freed from its flash by punching in a subsequent operation. This process provides configuration possibilities to the effect that, for example, the stem 3 can be provided with a profile 7, with which it is possible to increase the stability of the fixing component 1 and reduce its weight. The aforementioned exemplary embodiment is to be seen as one of many configurations, for example the fork 2 can accommodate the container tube 8, can provide support for the cylinder tube 9 and, by means of a different length configuration, can compensate for installation differences.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A shock absorber for installation between two masses, said damping element comprising:
a container tube containing a damping medium;
a piston arranged in said container tube for displacement in said damping medium;
a piston rod connected to said piston and being connectable to one of said masses; and
a fixing component comprising a base, a stem, and a fork which are made as a single piece, said base being fixed to said container tube, said fork being connectable to the other of said masses.

2. A shock absorber as in claim 1 wherein said fixing component is a forged component.

3. A shock absorber as in claim 1 wherein said fixing component is made of steel.

4. A shock absorber as in claim 1 wherein said stem has an elongate aperture.

5. A shock absorber as in claim 1 wherein said base comprises an extension which is received in said connecting tube and a shoulder which abuts said connecting tube.

6. A shock absorber as in 5 wherein said extension is received in said connecting tube in a press fit.

7. A shock absorber as in claim 5 wherein said extension is received in said connecting tube with play and secured to said connecting tube.

8. A shock absorber as in claim 7 wherein said base is secured in said connecting tube by one of pressing, adhesive bonding, welding, jointing, screw fixing, peening and soldering.
